(19) United States
(12) Patent Application Publication
(10) Pub. No.: US 2011/0276409 A1
(43) Pub. Date: Nov. 10, 2011

(54) SYSTEM AND METHOD FOR PROVIDING FEEDBACK ABOUT MERCHANTS USING PAYMENT TRANSACTIONAL INFORMATION

(76) Inventor: Wathik Labidi, Palo Alto, CA (US)

(21) Appl. No.: 13/101,830

(22) Filed: May 5, 2011

Related U.S. Application Data
(60) Provisional application No. 61/332,096, filed on May 6, 2010.

(51) Int. Cl. G06Q 99/00; G06Q 30/00

(52) U.S. Cl. 705/14.66; 705/347

(57) ABSTRACT

Information is analyzed from a user's financial account in order to identify one or more payment transactions between the user and a corresponding one or more merchants. The user is enabled to provide feedback, over a computer interface, about individual merchants, as identified from the information. Information about the merchant is published that incorporates or otherwise uses the feedback provided from the user.

### PRIORITY APPLICATION

This application claims benefit of priority to Provisional U.S. Patent Application No. 61/332,096, filed May 6, 2010, entitled SYSTEM AND METHOD FOR PROVIDING FEEDBACK ABOUT MERCHANTS USING PAYMENT TRANSACTIONAL INFORMATION; the aforementioned priority application being hereby incorporated by reference in its entirety.

### TECHNICAL FIELD

Embodiments described herein pertain generally to a system and method for providing feedback about merchants and businesses using payment transactional information.

### BRIEF DESCRIPTION OF THE DRAWINGS

FIG. 1 illustrates a computer implement method for enabling individuals to provide feedback about merchants and businesses using payment transaction information.

FIG. 2 illustrates a system for enabling individuals to provide feedback on merchant and businesses using information determined from their financial accounts, according to an embodiment.

FIG. 3 illustrates an interface for enabling individuals to provide feedback, under an embodiment.

FIG. 4 is a block diagram that illustrates a computer system upon which embodiments described herein may be implemented.

### DETAILED DESCRIPTION

Embodiments described herein provide for a computer-implemented method and system for identifying merchants and businesses that a person can review by analyzing purchase transaction information of a financial account of the user. Embodiments further enable the user to provide feedback through an interface that prompts the user for a rating or review. The feedback provided from multiple users can be combined, consolidated or otherwise aggregated and published on, for example, a web page or online directory.

In an embodiment, information is analyzed from a user's financial account in order to identify one or more payment transactions between the user and a corresponding one or more merchants. The user is enabled to provide feedback, over a computer interface, about individual merchants, as identified from the information. Information about the merchant is published that incorporates or otherwise uses the feedback provided from the user.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Overview

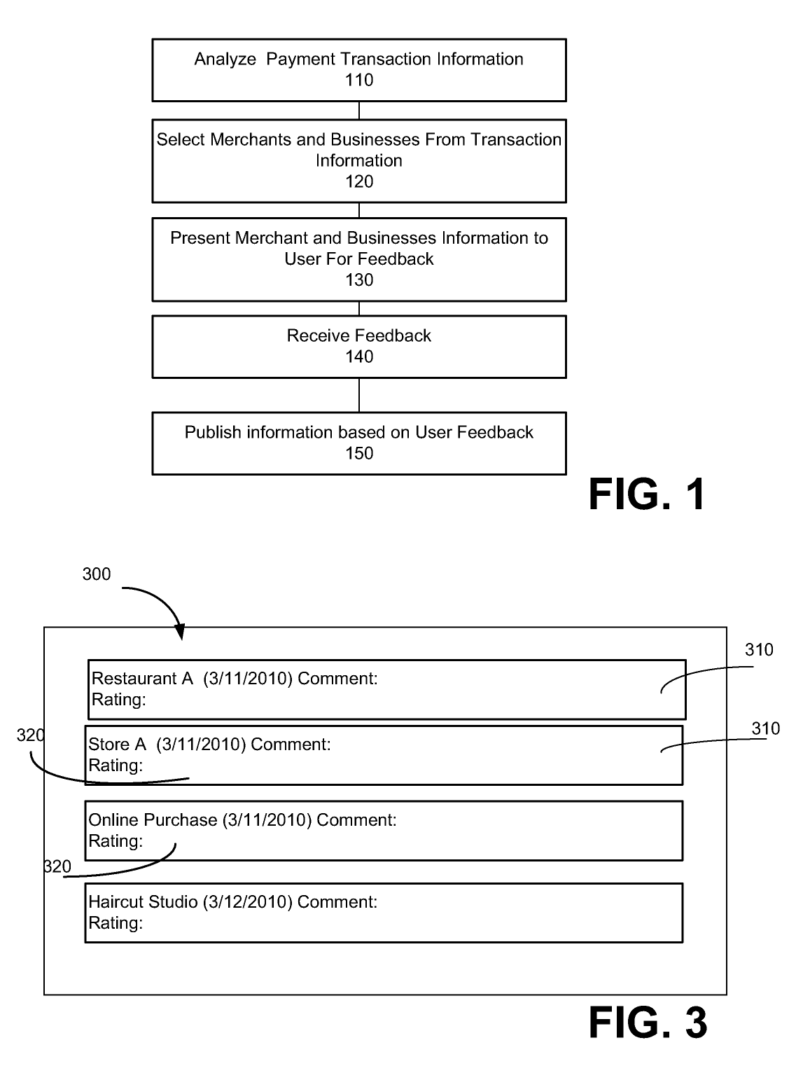

FIG. 1 illustrates a computer implemented method for enabling individuals to provide feedback about merchants using their payment transaction information. A method such as described may be implemented on, for example, a server (or servers) as part of a network service. Alternative computing environments may also be used in order to implement a method such as described.

With reference to FIG. 1, information from a user's financial account is analyzed in order to identify payment transaction information (110). Payment transaction information is information that identifies and provides information about a person's business transaction (e.g. purchase of product or service). For example, payment transaction information can be determined from analyzing transactional records of accounts associated with credit cards, debit cards, checking accounts or similar financial instruments or devices. Payment transaction information can also be determined from records of mobile devices (e.g. mobile phones, smart cards) that electronically transfer, or enable electronically transfer, or funds from the person to the merchant.

In some embodiments, the user's financial account is accessed from a network service. In particular, a service can be made available over a network (e.g. as a website), and the service may be configured to retrieve and analyze payment transaction information from financial accounts of its user base.

In other embodiments, the financial account and/or payment transaction information is accessed and analyzed from other environments. For example, in an alternative or variation, the payment transaction information is analyzed as part of a financial service (e.g. institution that manages the financial account), or as part of an intermediary service that facilitates or provides validation of transactions using, for example, credit cards, debit cards or similar instruments.

The payment transaction information is analyzed to determine one or more merchants that the user can provide feedback on (step 120). In an embodiment, all (or as many as possible) transactions are identified from the financial account, and a subsequent selection process is implemented in order to identify those merchants or transactions that are suitable for receiving user feedback. The selection process may be implemented to select only some merchants that satisfy criteria from those that can be identified from the financial information. More specifically, at least some merchants (or transactions) are selected based on criteria or parameters that anticipate the suitability of the individual merchants for receiving feedback from the user.

As part of the selection process, an embodiment implements a filtering parameter to eliminate from selection those payment transactions that have previously been presented to the user, or which have already received feedback from the user. In another embodiment, merchants are selected from the financial information based on a class or type designation. For example, some types of merchants may be excluded from receiving feedback because that merchant's type of business is not one that generally receives interest from the population in terms of reviews or feedback (e.g. gas stations).

Still further, individual transactions can be analyzed to determine, for example, the amount of the transaction or service that was purchased. A filtering or selection parameter can select merchants from transactions that satisfy, for example, a threshold amount (minimum) or range (minimum, maximum) for a transaction or transaction type.

Merchants identified from the payment transaction information are presented to the user for feedback (step 130). In an embodiment, merchants are presented to the user in list form. The list may comprise entries that identify the merchant, the transaction, and information about the transaction (e.g. dollar amount, date). The user can view the list, and provide feedback for merchants at the user's selection. The feedback may be in the form of a rating or order review (e.g. qualitative feedback).

In some implementations, the user is presented the list on a browser or other application that communicates with a service where the merchant identification information is analyzed. The user can operate a keyboard or similar text entry or input mechanism to provide the feedback.

The feedback for a particular merchant is received (step 140). In some embodiments, the feedback from a user is stored in a data structure that associates the user's feedback with the feedback of other users from the same merchant. Thus, feedback, as provided by different users for a given merchant, can be consolidated and/or aggregated. Additionally, information may be stored that links merchants by category and/or location. In this way, merchants can be categorized by type and geography, and individual merchants in each category/type are associated with respective feedback from users in a given population.

For a given merchant, information is published that is based on the feedback provided by a given user (step 150). The information published may correspond to (i) a qualitative review provided by a given user; (ii) a rating provided by a given user; (iii) a consolidated (e.g. average) rating provided by multiple users; or (iv) a consolidated or aggregated presentation of qualitative reviews and/or ratings provided by individual users. Other forms of information that reflect user feedback may alternatively be used.

According to embodiments, the information can be published in a variety of formats and mediums. In one embodiment, the information is published as part of a service that provides information about businesses. For example, a service may include a searchable online directory for businesses. As part of the online directory, the service may provide feedback information determined from information such as described with an embodiment of FIG. 1.

An embodiment such as described with FIG. 1 and elsewhere can be implemented to analyze payment transaction information from multiple financial accounts of a user. Furthermore, feedback from multiple users (or a population of users) can be aggregated, consolidated and/or summarized.

System Description

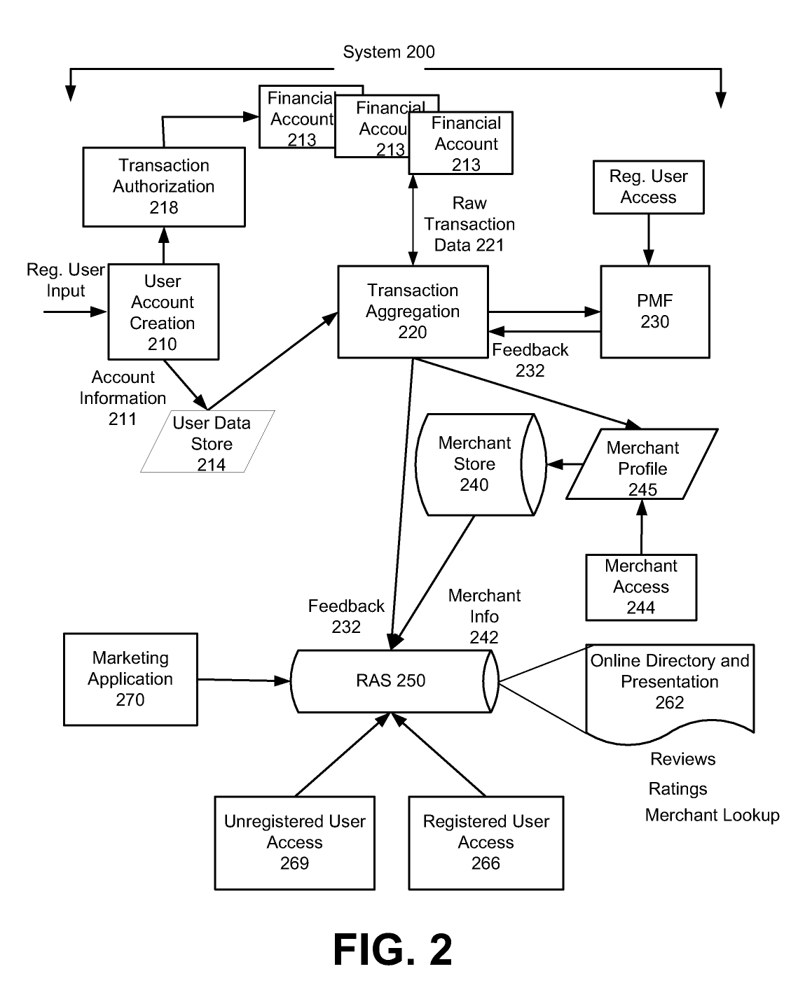

FIG. 2 illustrates a system for aggregating and presenting feedback information about merchants from a population of users, according to one or more embodiments. A system 200 such as described can be implemented as part of a service, such as one provided on a network (e.g. Internet) and accessed through a website. In an embodiment, the system 200 is comprised of processes that include account creation 210, transaction aggregation 220, and presentation of merchants for feedback (PMF) 230. A registered user may access account creation 210 using an interface in order to provide the user's account information to one or more financial accounts of the user. The account information 211 enables network access to the user's financial accounts 213. Specific examples of such information include the payment card number, the holding institution of the payment card, and the username and password for accessing a financial account online, as well the user's email address on record with the financial institution (that provides the account). The user account information can also include the answer to one or more security questions. In addition to account information, some embodiments provide that the user enters other information, including profile and/or demographic information. Specific examples of such information include the user's age, gender, income bracket, and zip code. Information provided or determined from the user input during account creation 210 is stored in the user data store 214.

By providing information through the account creation process 210, the user is able to link, for example, his or her payment cards to his or her user account with system 200. A transaction authorization process 218 can use the account information provided by the user in order to establish an initial link to enable subsequent access and retrieval of data from the account. Once a link to a financial institution holding the payment card has been established, the user is able to submit his/her preferences for payment cards transaction filtering. Specific examples of such preferences include (i) what business categories the user does not want to review; (ii) what merchants the user does not want to provide reviews for; and (iii) what thresholds and frequency the user wants to apply to the transactions to be presented to him/her for review.

According to an embodiment, user data store 214 stores a data set based on user demographic information, user preferences, system calculated scores as well as on past user reviews. According to some embodiments, the data set includes scores that can be used to retrieve, from the merchant store, relevant merchant references that the user would tentatively like to do business with. Still further, in some embodiments, the user data store 214 stores information used to provide recommendations to users that have similar account profile attributes.

The process of transaction aggregation 220 accesses the individual financial accounts of each registered user's account and retrieves raw transaction data 221. Transaction aggregation 220 links the raw transactions downloaded from the financial institution to the user's profile information in profile store 214. A pre-processing step can be implemented to identify from the raw data, payment transactions which satisfy a threshold, preferences of the user, and other system criteria (e.g. non-repeat transactions). The payment transactions that satisfy the various thresholds and criteria are communicated to the registered user via the PMF 230. The PMF 230 includes an interface that enables the registered user to provide feedback about specific merchants identified from transactions processed by transaction aggregation 220. In one implementation, the PMF 230 is provided as a webpage or web-based interface that presents information and enables the user to provide input reflecting the user's feedback about the transaction. An example of the interface provided with PMF 230 is shown in an embodiment of FIG. 3.

In some embodiments, the transaction aggregation 220 is used to populate data for PMF 230. The PMF 230 presents a list of entries to the user that correspond to select transactions that a particular user has had with a merchant. As mentioned, the transactions can be selected (by, for example, transaction aggregation 220) based on criteria and selection parameters. In an embodiment, the user enters input by way of a rating and/or qualitative feedback (e.g. a review).

According to some embodiments, the PMF 230 provides an interface (e.g. web interface) to the user in order to enable the user to identify or select the transaction that the user wants to enter input for at feedback 232. The same interface can be used to allow the users to discard transactions that they do not deem worthy of their review (example: a review of a highway toll transaction is probably not significant). In an embodiment, the PMF 230 allows the user to: (i) submit an overall rating for the transaction (e.g. number of points out of 5, number of stars out of 5); (ii) if desired, submit a qualitative review of the transaction, depending on the type of business. The qualitative review can be used to compute a transaction score through an algorithm that factors information such as the business type, the user profile and the submitted qualitative ratings, along with other information the system has access to.

The qualitative rating can be adjusted for every business type to include the meaningful aspects of the business transactions as they relate to the business or transaction type. Specific examples, include (i) a dry-cleaner related transaction will have as attributes among others: price, quality of the cleaning, quality of the pressing, welcoming business; and (ii) a hotel related transaction will have as attributes: price, room size, quietness, cleanness, quality of service, location. The user may also be able to submit a comment to accompany a rating or review.

In an embodiment, the PMF 230 incorporates functionality to allow the user to update feedback 232 previously provided by the user for a merchant. For example, a user may update his or her review of a merchant based on the user's experience with that merchant in recent transactions. Additionally, PMF 230 can be structured to recognize repeat transactions and to automatically prompt or present the user to submit a new review (or resubmit an old review/feedback) as a current representative opinion of the business.

A merchant store 240 retains information about individual merchants. This information includes identification of individual merchants, particularly those that have been predetermined as being suited for receiving feedback from users through the use of payment transaction information. The merchant store 240 can include a directory or listing of businesses. As an additional or alternative, merchant store 240 may maintain information directly provided from merchants that subscribe or otherwise participate with the service provided. In one embodiment, merchant access 244 enables merchants to enter information about themselves, such as the business name and address, as well as the location and type of business.

In one embodiment, the user feedback engine includes an auto-learning capability that adjusts to record transaction types that are not worthy of user reviews, so as to automatically exclude such transactions from being presented to users, unless explicitly requested.

In an embodiment, merchant access 244 enables registered merchants to access features that include (i) a merchant profile 245, and (ii) a campaign engine. The merchant profile 245 includes information that is (i) automatically generated from transaction aggregation process 220, and/or (ii) manually entered by the registered merchant. For example, registered merchants can subscribe to a merchant service provided by system 200. As part of the service, the merchant can maintain an account, and supply information (e.g. picture, descriptions) to promote their business. For example, as part of the website or service provided, individual merchants can link to (or maintain) web pages or web storefronts. The merchants can also update and maintain information in other formats. For example, this information may specify their business name, updated information about products offered, store attributes, contact information, promotional material, and coupons.

In an embodiment, merchant access 244 includes an interface that allows the merchant to develop its web page or storefront resource. The merchant may use the interface to provide information that includes, for example, (i) a description (including pictures) of the business, (ii) product/service description, including menus or lists of services, and (iii) marketing specials (e.g. holiday sales).

In an embodiment, a review and appraisal store (RAS) 250 references feedback 232, as provided by transaction aggregation 220 (or directly through PMF 230), with merchant information 242. The merchant information 242 can correspond to information stored in merchant store 240. In this way, RAS 250 links feedback 232 with the specific merchants that receive the feedback. The feedback 232 can then be displayed with merchant information, such as the merchant's webpage or profile. As an addition or variation, feedback information 232 can be provided as part of an online directory and presentation 262.

The online directory can be made searchable and/or browsable. In some embodiments, the user (registered and/or unregistered) may incorporate ratings or feedback into criteria or parameters for performing searches for businesses.

There are numerous applications for information of RAS 250. For example, registered user access 266 may enable registered users superior access to information provided in the RAS 250, such as the ability to see all user reviews, or to receive recommendations to merchants based on established preferences, including profile information and calculated scores relevant to the registered user.

More specific examples of applications for registered user access 266 include the following. Registered users may express information about their demographic (e.g. age, sex, income) and preferences. As an alternative or variation, intelligence may be incorporated into a system such as shown in order to determine specific preferences of the user, such as the user's preference for a particular type of cuisine. Such programmatically determined preferences can be readily obtained through analysis or monitoring of the user's feedback. For example if the user provides high ratings for multiple restaurants of a particular type of cuisine, programmatic intelligence may characterize the user as having a preference for that kind of cuisine. The user's characterization in this regard may be used to provide that user with, for example, recommendations or suggestions to alternative restaurants (e.g. those preferred by other users who have similar preferences or who have provided similar feedback), recommendations or suggestions to products or services that people with similar profile, interests or taste have shown an affinity for (e.g. users who prefer a certain restaurant have an affinity for a particular type of wine). Such affinity will be derived through the comparison of relevant system calculated scores and comparisons of users profile information.

In one embodiment, when connected to the system using a web browsing mechanism to perform search requests for businesses or merchants, the authentified registered users will be shown ads and offers of businesses that are determined by their relevance using the users profile information and system calculated scores. When the users choose to receive offers through emails as part of their account profile information, such promotional material will also be sent to the inbox through an electronic messaging system.

Unregistered users may also be provided access to RAS 250. Her example, in some implementations, unregistered user access 269 can include, for example, browsing and searching of a directory of merchants in order to view the merchant profiles, webpages, and ratings and/or reviews.

Other applications for review and appraisal information include marketing applications 270. In one embodiment, a service may interface with the RAS 250 to identify information such as (i) what merchants are like in a particular category (e.g. restaurants in a particular area), (ii) demographic and profile based information about users who have positive (or conversely negative) feedback for a particular business, and (iii) demographic and profile based information about patrons who visited a particular establishment or type of establishment in a given period of time.

### APPLICATIONS

In some embodiments, information determined from a system such as described with FIG. 2 may be integrated into presenting an online directory of businesses. Ratings and reviews provided to businesses through a system such as described can be integrated into information presented about individual businesses.

Still further, in some embodiments, the online directory is searchable or browsable to users. The search and/or browse activities can incorporate rating information (as provided by embodiments described herein). For example, a user can search restaurants by category, and view those restaurants that have the highest rating based on feedback provided by users of the directory.

As an addition or alternative, some embodiments incorporate user profiles that are based on demographic information, preferences and transaction history, in order to perform campaign and marketing functions. For example, marketing campaigns for specific types of businesses (e.g. restaurant of particular ethnicity) may target those individuals that have transacted with similar businesses (e.g. same type of restaurant), and who have provided positive reviews of such businesses.

In addition to campaigns, one or more embodiments provide for selecting and/or targeting advertisements to individuals based on profile information (e.g. combination of demographic, transaction history and/or reviews). As a specific example, advertisements may be targeted to persons as web content, in connection with their use of an online directory such as maintained with an embodiment of FIG. 2. As an alternative to advertisement, promotion content and material can be targeted to individuals (e.g. coupons).

Feedback Interface

FIG. 3 illustrates an interface for presentation of merchant feedback, according to an embodiment. As described with other embodiments, payment transaction information is processed to identify select transactions that satisfy selection criteria or parameters (e.g. price for transaction, type of product or service etc.). The select transactions can be extracted from payment transactional information of a particular account, and consolidated and presented to the user for feedback.

In one embodiment, the interface for presentation of merchant feedback is provided as an interactive list 300, comprising entries 310 that correspond to select transactions identified from the user's payment transactional information. The list 300 can be generated from payment transactional information contained in one or more of the user's financial accounts. For example, a list may be generated from two or more credit or debit card accounts of the user. Each entry 310 can identify the merchant, as well information about the particular transaction between the user and the merchant. The transaction information can include, for example, (i) the date of the transaction, (ii) the amount of the transaction, and (iii) information about the merchant, including the merchant name and location or address. An input field 320 is provided with each entry 310. In the particular implementation shown, the entry field 320 receives text information, such as provided when the user provides a qualitative review. The input field 320 can be dimensioned or presented to encourage (or even limit) relatively short reviews, such as those provided with micro-blogging (e.g. less than 160 characters). As an alternative or variation, input fields may be provided to facilitate or prompt the user into entering a quantitative feedback, such as a rating. Still further, other variations can enable the user to enter substantial commentary, such as in paragraph or paginated form, for a particular merchant.

In addition, and whether or not the system has been able to provide a category for the merchant or the business associated with the transaction, the user can choose to provide a category to the business as well as proceed with providing a qualitative feedback for the transaction. Such qualitative feedback will be based on pre-determined attributes that are relevant to the business or the merchant category.

Computer System

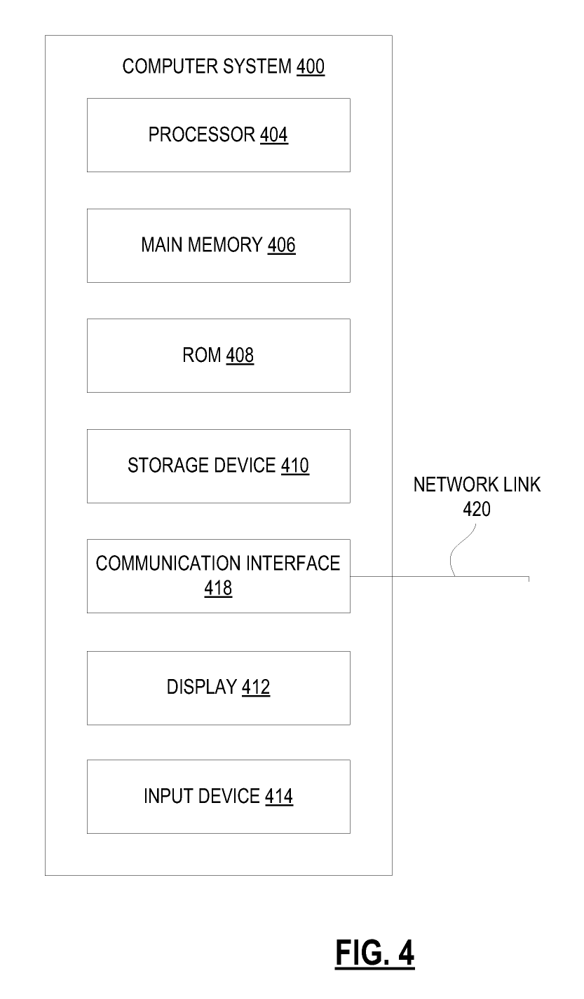

FIG. 4 is a block diagram that illustrates a computer system upon which embodiments described herein may be implemented. For example, in the context of FIG. 2, system 200 may be implemented using a computer system such as described by FIG. 2.

In an embodiment, computer system 400 includes processor 404, main memory 406, ROM 408, storage device 410, and communication interface 418. Computer system 400 includes at least one processor 404 for processing information. Computer system 400 also includes a main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 may also include a read only memory (ROM) 408 or other static storage device for storing static information and instructions for processor 404. A storage device 410, such as a magnetic disk or optical disk, is provided for storing information and instructions. The communication interface 418 may enable the computer system 400 to communicate with one or more networks through use of the network link 420.

Computer system 400 can include display 412, such as a cathode ray tube (CRT), a LCD monitor, and a television set, for displaying information to a user. An input device 414, including alphanumeric and other keys, is coupled to computer system 400 for communicating information and command selections to processor 404. Other non-limiting, illustrative examples of input device 414 include a mouse, a trackball, or cursor direction keys for communicating direction information and command selections to processor 404 and for controlling cursor movement on display 412. While only one input device 414 is depicted in FIG. 4, embodiments may include any number of input devices 414 coupled to computer system 400.

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of the invention is defined by the claims and their equivalents. Furthermore, it is contemplated that a description of a particular feature, when provided individually or as part of an embodiment, can be combined with other individually described features, or parts of other embodiments. Thus, the absence of describing combinations should not preclude the inventor from claiming rights to such combinations.

What is claimed is:

1. A computer implemented method for providing feedback about merchants and businesses and the transactions that are being processed with them by individuals or companies, the method comprising:
analyzing information from a user's financial account to identify one or more payment transactions between the user and a corresponding one or more merchants and businesses;
enabling the user to provide feedback, over a computer interface, about each of the one or more merchants and businesses; and
publishing information that is based on the feedback.

2. The method of claim 1, wherein the feedback corresponds to a rating or a review of the merchant or the business, and/or to a series of scores calculated by the system.

3. The method of claim 1, wherein analyzing information from the user's financial account includes identifying a plurality of payment transactions from the information, including their corresponding plurality of merchants and businesses.

4. The method of claim 1, wherein enabling the user to provide feedback includes:
presenting information that identifies at least some of the plurality of merchants and businesses to the user on a computer-generated interface, and
enabling the user to provide a rating and/or a qualitative input about each of the plurality of merchants and businesses.

5. The method of claim 4, wherein presenting information that identifies at least some of the plurality of merchants and businesses includes forming a list that identifies at least some of the plurality of payment transactions.

6. The method of claim 4, further comprising filtering the plurality of merchants and businesses that are to be presented to the user for feedback.

7. The method of claim 1, further comprising:
receiving information and authorization from a user to programmatically access the user's financial account(s) over a network; and
retrieving transactional information from the user's financial account(s) using the network.

8. The method of claim 7, wherein retrieving transactional information from the user's financial account is performed on a schedule or in realtime, depending of the circumstances.

9. The method of claim 7, wherein retrieving transactional information from the user's financial account is performed

10. The method of claim 1, wherein publishing information that is based on the merchant or the business feedback and scores includes publishing the information on a webpage.

11. The method of claim 1, further comprising aggregating feedback for individual merchants or businesses from multiple users, and wherein publishing the information that is based on the feedback includes publishing the feedback on a webpage that includes feedback from one or more other users.

12. The method of claim 1, wherein publishing information that is based on the feedback includes publishing a consolidated rating that is based on a plurality of ratings provided from multiple users, including a rating provided from the user.

13. The method of claim 1, further comprising maintaining one or more data stores that includes information about a directory of businesses, merchants and registered users.

14. The method of claim 1, further comprising calculating scores as a rating of the merchants, businesses and registered users, and then associating the scores with the businesses, merchants and registered users in the one or more data stores.

15. The method of claim 14, further comprising publishing data from the one or more data stores as an online directory for businesses and merchants.

16. The method of claim 15, further comprising enabling the online directory to be searched and/or reviewed.

17. The method of claim 16, further comprising enabling use of selection criteria, along with user profile information, to determine a possible match between a user and a business or a merchant.

18. The method of claim 17, further comprising generating a marketing campaign using, among other elements, the users profile information, their calculated score, their reviews of the payment transaction as well as other data elements related to the payment transactions.

19. The method of claim 18, further comprising selecting advertisements for the user from a repository using the user profile information.

20. The method of claim 19, further comprising selecting advertisements for the user based on individual reviews and/or the transaction history of the user.

21. The method of claim 20, wherein selecting advertisements includes displaying selected advertisements to the user when the user views content from the online directory.
